(19) United States
(12) Patent Application Publication
(10) Pub. No.: US 2001/0037594 A1
(43) Pub. Date: Nov. 8, 2001

(54) Customizable family display and method of use

(76) Inventor: Robert Bohen, Trabuco Canyon, CA (US)

Correspondence Address: ERIC K. KARICH, 905 TURNBERRY DRIVE, MANSFIELD, TX, 76063, US

(21) Appl. No.: 09/848,944

(22) Filed: May 3, 2001

Related U.S. Application Data
(60) Provisional application No. 60/203,268, filed on May 4, 2000.

(51) Int. Cl. G09F 7/12

(52) U.S. Cl. 40/594

(57) ABSTRACT

A customizable family display has a background sheet that provides a display area and a plurality of figures that together represent a family. The plurality of figures are arranged on the display area of the background sheet, enabling a user to create a custom display of their individual family, and display the custom display to show pride in their family.

### CROSS-REFERENCE TO RELATED APPLICATIONS

This application for a utility patent claims the benefit of U.S. Provisional Application No. 60/203,268, filed May 4, 2000.

### BACKGROUND OF THE INVENTION

1. Field of the Invention

This invention relates generally to stickers, and more particularly to a plurality of stickers that enable a user to construct a custom family display to show pride in his or her family.

2. Description of Related Art

Stickers are a well known means for communicating an individual's thoughts and beliefs. Stickers can be imprinted with almost any message, large or small, written or graphic, and adhered to almost any surface to display the message to the world. One popular type of sticker, known as a “bumper sticker,” is commonly placed on the rear of a vehicle to ensure that a large number of people see the message on the sticker.

The prior art teaches the use of stickers to communicate a message. However, the prior art does not teach a sticker that can be readily customized to display information about a user's family, to show pride in his or her family. The present invention fulfills these needs and provides further related advantages as described in the following summary.

### SUMMARY OF THE INVENTION

The present invention teaches certain benefits in construction and use which give rise to the objectives described below.

The present invention provides a customizable family display having a background sheet that provides a display area and a plurality of figures that together represent a family. The plurality of figures are arranged on the display area of the background sheet, enabling a user to create a custom display of their individual family, and display the custom display to show pride in their family.

A primary objective of the present invention is to provide a customizable family display having advantages not taught by the prior art.

Another objective is to provide a customizable family display that enables a user to create a custom display of their individual family to show pride in his or her family

Other features and advantages of the present invention will become apparent from the following more detailed description, taken in conjunction with the accompanying drawings, which illustrate, by way of example, the principles of the invention.

### BRIEF DESCRIPTION OF THE DRAWING

The accompanying drawings illustrate the present invention. In such drawings:

FIG. 1 is a top plan view of the preferred embodiment of the present invention, a customizable family display;

FIG. 2 is a top plan view showing a user placing one of a plurality of figures on a background sheet;

FIG. 3 is a perspective view showing the customizable family display attached to a truck with a primary adhesive backing; and

FIG. 4 is a back elevational view of an alternative embodiment of the customizable family display wherein the background sheet includes a suction cup.

### DETAILED DESCRIPTION OF THE INVENTION

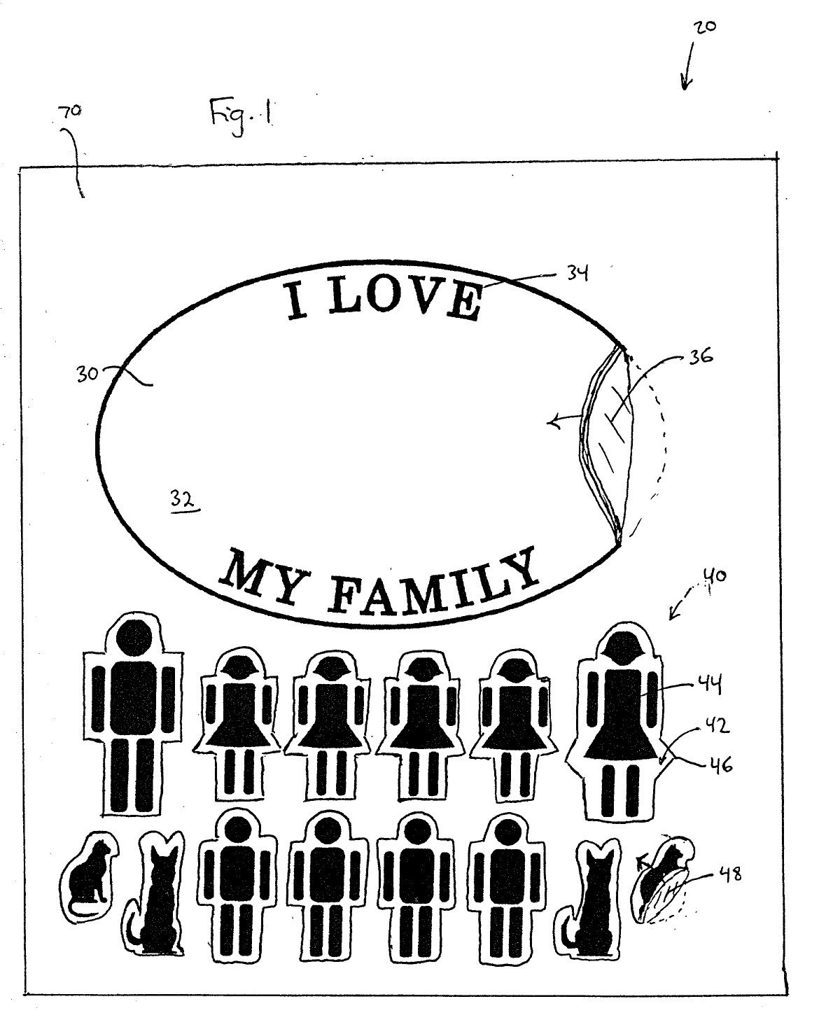

The above described drawing figures illustrate the invention, a customizable family display 20 for showing membership in a family. As shown in FIG. 1, the customizable family display 20 includes two primary components, a background sheet 30 that provides a display area described below, and a plurality of figures 40 that together represent a family. The customizable family display 20 enables a user 10 to create a custom display of their individual family, and display the custom display to show pride in their family.

As shown in FIGS. 1 and 4, the background sheet 30 includes a front surface 32 and an opposing back surface 36, preferably in the form of a plastic or laminated paper sheet. The front surface 32 is imprinted with a family center indicia 34 representing a center of the family. In the preferred embodiment, as shown in FIG. 1, the family center indicia 34 is formed simply by printing the words “I LOVE MY FAMILY.” In alternative embodiments, various symbols of family can be used, including a simple picture of a family home, or similar words and/or imagery that represent home and family values. The family center indicia 34 is preferably printed onto the front surface 32, although any suitable form of printing, etching, engraving, painting, layering, drawing, or other method of marking or coloring is acceptable.

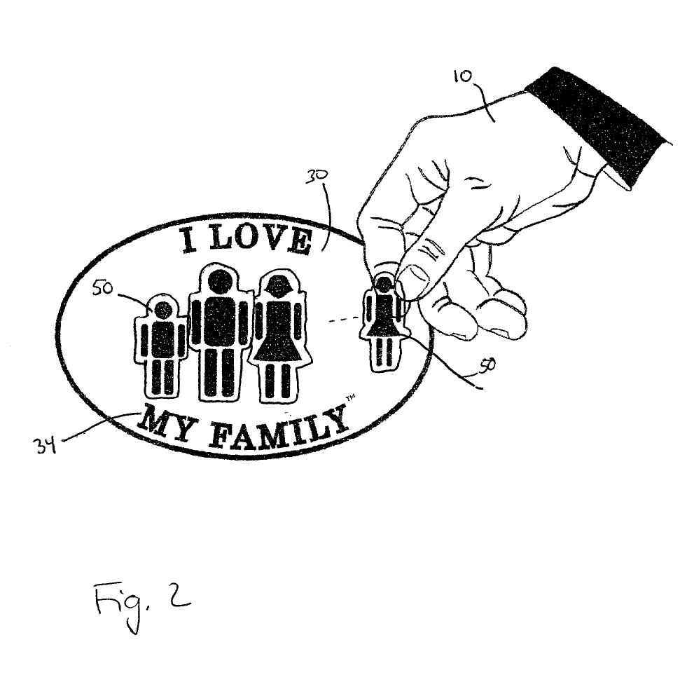

As shown in FIGS. 1 and 2, each of the plurality of FIGS. 40 includes a figure front surface 42 and an opposing figure back surface 48. The figure front surface 42 is imprinted with a figure indicia 44 to represent a member in the family. The figure indicia 44 is preferably a printed figure of a generic representation of an adult male figure, an adult female figure, a male child figure, a female child figure, a dog figure, and a cat figure, although other pets and family members can also be included. The figure indicia 44 is imprinted upon the figure front surface 42 in the same manner as the family center indicia 34, as described above. In the preferred embodiment, each of the plurality of figures 40 further includes a shaped perimeter 46. Thee shaped perimeter 46 cooperates with the figure indicia 44 to represent the member of the family. For example, the one of the plurality of figures 40 that represents a dog would preferably have a shaped perimeter 46 that is shaped like the silhouette of a dog.

As shown in FIG. 1, the figure back surface 48 preferably includes an adhesive backing. In the preferred embodiment, the adhesive backing is an ordinary adhesive commonly used in stickers, tape, and the like. In an alternative embodiment, each of the plurality of figures 40 is constructed of a slightly tacky plastic or rubber that tends to adhere to the plastic or rubber background sheet 30. Such naturally adhesive properties of plastics are well known to those skilled in the art. Since the nature of the adhesive used is not important to this invention, any method of adhering the plurality of figures 40 to the background sheet 30 should be considered within the scope of this invention.

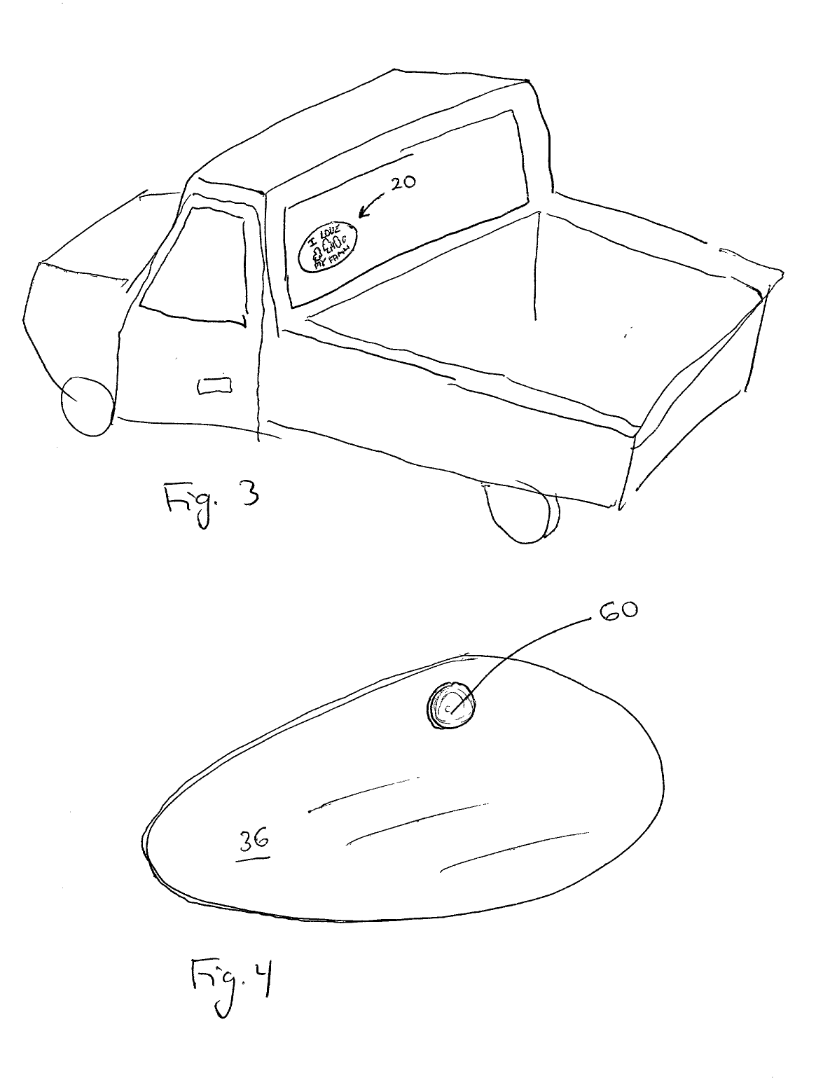

As shown in FIG. 3, the customizable family display 20 further includes a means for hanging 60 the background sheet 30 in a suitable location for displaying pride in and loyalty to the family. In the preferred embodiment, as shown in FIG. 3, the opposing back surface 36 has a primary adhesive backing that allows the background sheet 30 to be adhered to a surface such as the back of an automobile. In an alternative embodiment, as shown in FIG. 4, the means for hanging 60 is a suction cup 60 attached to the background sheet 30, thereby allowing the background sheet 30 to be removably adhered to the back window of an automobile. Once again, since the specific nature of the means for hanging 60 is not critical to this invention, any means for hanging 60 the background sheet 30 should be considered within the scope of this invention.

The customizable family display 20 preferably further includes a sheet of peel-removable paper 70 to which both the background sheet 30 and the plurality of figures 40 are removably adhered. The background sheet 30 is preferably removably attachable to the sheet of peel-removable paper 70 by the primary adhesive backing; and the plurality of figures 40 are preferably removably attachable to the peel-removable paper 70 by the adhesive backing of each of the plurality of figures 40.

The invention includes a method for using the above-described customizable family display 20 to show pride in one's family. In the preferred embodiment, the user 10 purchases the customizable family display 20, the background sheet 30 and the plurality of figures 40 being adhered to the sheet of peel-removable paper 70. The user then selects at least two select figures 50 that together represent the family are selected from the plurality of figures 40. For example, a user 10 who is a newly married male might select an adult male figure for himself, an adult female figure for his wife, and a dog figure for their pet dog. Together, the at least two select figures 50 selected represent the family of the user 10 at that time.

Each of the at least two select figures 50 is then placed onto the background sheet 30 such that the adhesive backing of each of the at least two select figures 50 adheres to the front surface 32 of the background sheet 30. The combination of the at least two select figures 50 and the family center indicia 34 tell the world that the user 10 has a family of which he or she is proud. The user 10 then hangs the background sheet 30 with the means for hanging 60, for example, by peeling the background sheet 30 from the peel-removable paper 70 and sticking the background sheet 30 onto the back of an automobile of the user 10. In the preferred embodiment, the user 10 takes reasonable steps to place the at least two select figures 50 onto the background sheet 30 with some care, lining them up so they look nice and well ordered.

As time goes on, the user 10 might have children. According to the method of this invention, the user 10 would simply select additional figures that represent additions to the family. When the user 10 has a son, for example, the male child figure could be added to the background sheet 30. When the user 10 has a daughter, a cat, or a second son, appropriate figures could be added to the background sheet 30. This allows the customizable family display 20 to grow with the user 10, always representing the correct composition of the family of the user 10.

The customizable family display 20 not only allows the user 10 to show pride in family, it also serves an important safety concern. If there is an accident, such as an automobile accident or house fire, and the safety officers can readily see the composition of the family, they are better able to search for and rescue the entire family.

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. A customizable family display for showing membership in a family, the customizable family display comprising:
a background sheet having front surface and opposing back surface, the front surface being imprinted with a family center indicia representing a center of the family, the opposing back surface having a primary adhesive backing; and
a plurality of figures, each of the plurality of figures having a figure front surface and an opposing figure back surface, the figure front surface being imprinted with a figure indicia to represent a member in the family, and the figure back surface having an adhesive backing.

2. The customizable family display of claim 1 further comprising a sheet of peel-removable paper, the background sheet being removably adhered to the peel-removable paper by the primary adhesive backing, and the plurality of figures being removably adhered to the peel-removable paper by the adhesive backing of each of the plurality of figures.

3. The customizable family display of claim 1 wherein each of the plurality of figures further includes a shaped perimeter, the shaped perimeter cooperating with the figure indicia to represent the member of the family.

4. The customizable family display of claim 1 wherein the plurality of figures includes an adult male figure, an adult female figure, a male child figure, a female child figure, a dog figure, and a cat figure.

5. A customizable family display for showing membership in a family, the customizable family display comprising:
a background sheet having front surface imprinted with a family center indicia representing a center of the family;
a plurality of figures, each of the plurality of figures having a figure front surface and an opposing figure back surface, the figure front surface being imprinted with a figure indicia to represent a member in the family, and the figure back surface having an adhesive backing; and
a means for hanging the background sheet.

6. The customizable family display of claim 1 further comprising a sheet of peel-removable paper, the plurality of figures being removably adhered to the peel-removable paper by the adhesive backing of each of the plurality of figures.

7. The customizable family display of claim 1 wherein the means for hanging is a suction cup attached to the background sheet.

8. The customizable family display of claim 1 wherein each of the plurality of figures further includes a shaped perimeter, the shaped perimeter cooperating with the figure indicia to represent the member of the family.

9. The customizable family display of claim 1 wherein the plurality of figures includes an adult male figure, an adult female figure, a male child figure, a female child figure, a dog figure, and a cat figure.

10. A method for showing membership in a family, the method comprising the steps of:
a) providing a customizable family display for showing membership in a family, the customizable family display comprising:
a background sheet having front surface imprinted with a family center indicia representing a center of the family;
a plurality of figures, each of the plurality of figures having a figure front surface and an opposing figure back surface, the figure front surface being imprinted with a figure indicia to represent a member in the family, and the figure back surface having an adhesive backing; and
a means for hanging the background sheet;
b) selecting, from the plurality of figures, at least two select figures that together represent the family;
c) placing each of the at least two select figures onto the background sheet such that the adhesive backing of each of the at least two select figures adheres to the front surface of the background sheet; and
d) hanging the background sheet with the means for hanging.
